(19) United States
(12) Patent Application Publication
(10) Pub. No.: US 2023/0256644 A1
(43) Pub. Date: Aug. 17, 2023

(54) COMBINATION SERVICE CAN FOR POWER TOOLS

(71) Applicant: Michael KLAIN, Santa Maria, CA (US)

(72) Inventor: Michael KLAIN, Santa Maria, CA (US)

(21) Appl. No.: 18/108,602

(22) Filed: Feb. 11, 2023

Related U.S. Application Data
(60) Provisional application No. 63/309,578, filed on Feb. 13, 2022.

(51) Int. Cl. B27B 17/12; H02J 7/00

(52) U.S. Cl. CPC B27B 17/12; H02J 7/0045; H02J 2207/20

(57) ABSTRACT

The invention provides a combination service can for use with battery powered power tools, including battery powered chainsaws. The combination service can provide a single unit that is adapted to store and transport bar and chain oil, and to store, transport and charge rechargeable power tool batteries.

### CROSS-REFERENCE TO RELATED APPLICATIONS

This application claims the benefit of provisional application No. 63/309,578 filed Feb. 13, 2022, the entire contents of which are incorporated herein by reference for all purposes.

### FIELD OF THE INVENTION

The invention generally relates to power tools. More particularly, the invention relates to a combination service can for battery powered chainsaws.

### BACKGROUND OF THE INVENTION

Gas-powered chainsaws require a fuel mixture and bar and chain oil in order to function. Thus, these components need to be kept near a chainsaw in order for the chainsaw to be used in any cutting operation. Combination service cans have been used to make the storage and transportation of fuel mixtures and bar and chain oil convenient. Combination service cans incorporate a pair of vessels for separately containing a fuel mixture and bar chain oil. These cans are particularly useful in remote cutting operations, such as logging, forest maintenance, and fire-fighting applications.

Environmental demands, government regulations, and improvements in battery technology have influenced the transition away from gas-powered chainsaws towards battery powered chainsaws. While battery powered chainsaws do not require a fuel mixture, they still require bar and chain oil to function. In addition, battery operated chainsaws require a steady supply of charged batteries to complete most cutting operations. Like conventional chainsaws, battery powered chainsaws require accessories, such as extra cutting chains and wrenches for removing and replacing cutting chains. Thus, there is a need for a weatherproof service can that is capable of servicing modern, battery powered chainsaws and provides the convenient transportation of chainsaw accessories.

### SUMMARY OF THE INVENTION

The invention meets the needs of servicing modern, battery powered chainsaws by providing a combination service can that is weatherproof and capable of storing and transporting bar and chain oil and storing, transporting and charging batteries for chainsaws and other power tools.

It is therefore an object of the invention to provide a combination service can comprising a vessel adapted to contain a liquid, at least one battery receptacle adapted to receive a power tool battery, and a first electrical connector that is adapted to electrically couple to said power tool battery when said power tool battery is placed in said at least one battery receptacle.

In some aspects, the combination service can includes a second electrical connector that is electronically coupled to the first electrical connector, wherein the second electrical connector is adapted to electrically couple to an external power source.

In some aspects, the combination service can includes a charging battery that is electronically coupled to the first electrical connector and the second electrical connector, wherein the charging battery is adapted to charge a power tool battery that is placed in the at least one battery receptacle, and to receive charging voltage from the second electrical connector.

In some aspects, the at least one battery receptacle is adapted to receive a chainsaw battery.

In some aspects, the at least one battery receptacle comprises a guide rail that is adapted to mate with a power tool battery.

In some aspects, the combination service can includes a locking mechanism that is adapted to releasably hold the power tool battery within the at least one battery receptacle.

In some aspects, the vessel is adapted to contain bar and chain oil.

In some aspects, the vessel has an internal volume of between about 1 liter and about 3 liters.

In some aspects, the combination service can includes a compartment that is adapted to store one or more power tool accessories.

In some aspects, the compartment comprises two or more charging ports that are adapted to charge an electronic device.

In some aspects, the compartment is positioned between the vessel and the at least one battery receptacle.

In some aspects, the vessel, the at least one battery receptacle, and the compartment are enclosed in a housing.

In some aspects, the housing includes a spout that is adapted to dispense a liquid from the vessel.

In some aspects, the at least one battery receptacle is covered by a weatherproof hinged door.

In some aspects, the compartment is covered by a weatherproof hinged door.

In some aspects, the door of the at least one battery receptacle is adapted to maintain contact between the first electrical connector and terminals on a power tool battery.

In some aspects, the combination service can includes two or more battery receptacles.

In some aspects, the combination service can includes an AC/DC adapter.

### BRIEF DESCRIPTION OF THE DRAWINGS

FIG. 1 is a perspective view of a combination service can according to an embodiment of the invention wherein the battery receptacle doors and compartment door are open.

FIG. 2 is a perspective view of a combination service can according to an embodiment of the invention wherein the battery receptacle doors are closed.

FIG. 3 is a cross-sectional view of a combination service can according to an embodiment of the invention wherein the battery receptacle doors are open.

FIG. 4 is a cross-sectional view of a combination service can according to an embodiment of the invention wherein the combination service includes a charging battery.

The figures referred to above are not necessarily drawn to scale and should be understood to present a representation of the invention, illustrative of the principles involved. Some features of the invention depicted in the drawings may have been enlarged or distorted relative to others to facilitate explanation and understanding. The same reference numbers are used in the drawings for similar or identical components and features shown in various alternative embodiments. The invention, as disclosed herein, will have configurations and components determined, in part, by the intended application and environment in which it is used.

### DETAILED DESCRIPTION

The invention provides a combination service can for servicing battery powered power tools, including battery powered chainsaws. The combination service can provides for the transportation and storage of bar and chain oil and includes transportation, storage, and charging functions for rechargeable power tool batteries.

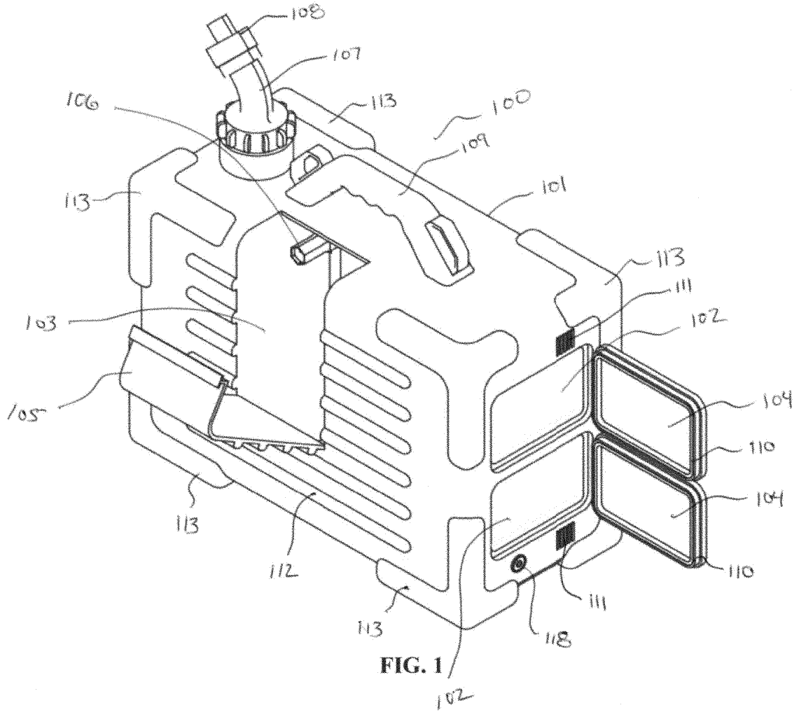

FIG. 1 is a perspective view of combination service can 100 according to an embodiment of the invention. Combination service can 100 features housing 101 which encloses battery receptacles 102 and compartment 103. Battery receptacles 102 are adapted to receive a rechargeable power tool battery. Battery receptacle doors 104 enclose the space within battery receptacles 102 and can be connected to housing 101 in a hinged relationship. Compartment 103 can feature compartment door 105 which can be in a hinged relationship with housing 101. Compartment door 105 can feature a weatherproof seal for preventing or inhibiting water and dust from entering compartment 103. Battery receptacle doors 104 and compartment door 105 can include latches for maintaining the doors in a closed position. Compartment 103 can be of a size and dimension suitable for storing and transporting one or more power tool accessories, such as, for example, spare chainsaw chains, chainsaw wrenches, and other hand tools (e.g., screwdrivers, end wrenches, ratchets, and the like), or extra rechargeable power tool batteries. Compartment 103 can feature stud 106 for securing a chainsaw wrench. In some embodiments, compartment 103 features compartment charging ports (not shown) that can be adapted to electronically interface and charge personal electronic devices, such as cell phones, iPads, organizers, iPods, MP3 players and other personal music players, and the like. The compartment charging ports can be one or more charging connections, or one or more USB receptacles for receiving a charging cord for a personal electronic device. Thus, compartment 103 can provide a weatherproof compartment for charging personal devices in remote locations while protecting the personal devices from the elements, such as sun, wind, and rain.

Housing 101 features spout 107 with cap 108 which can be a twist-off, locking cap. Handle 109 is attached to housing 101. In a preferred embodiment, handle 109 forms an opening with housing 101 that is of a sufficient size for an ax handle to fit through so that combination service 100 can be carried on the end of an ax against the ax blade.

Battery receptacle doors 104 can feature seals 110 to prevent or inhibit the passage of water and dust into battery receptacles 102. Seals 110 can be made of a resilient material such as rubber or silicone, for example. Housing 101 can include vents (not shown) which feature apertures for permitting heat to escape from the space of battery receptacles 102 during the charging of power tool batteries within the space of battery receptacles 102. While the figures herein depict combination service can 100 with two battery receptacles 102, it will be appreciated that combination service can 100 can have a single battery receptacle 102, or two or more battery receptacles 102.

Housing 101 can include a series of ribs 112 for providing housing 101 with rigidity and strength. Housing 101 can include corner reinforcements 113 for strengthening housing 101 against shock forces and abrasion. Corner reinforcements 113 can be attached to housing 101 by fasteners such as screws or rivets, or can form thickened portions of housing 101. Suitable materials for the construction of housing 101, handle 109, ribs 112, corner reinforcements 113, battery receptacle doors 104, and compartment door 105, include, but are not necessarily limited to, steel, aluminum, high density plastics, and combinations thereof.

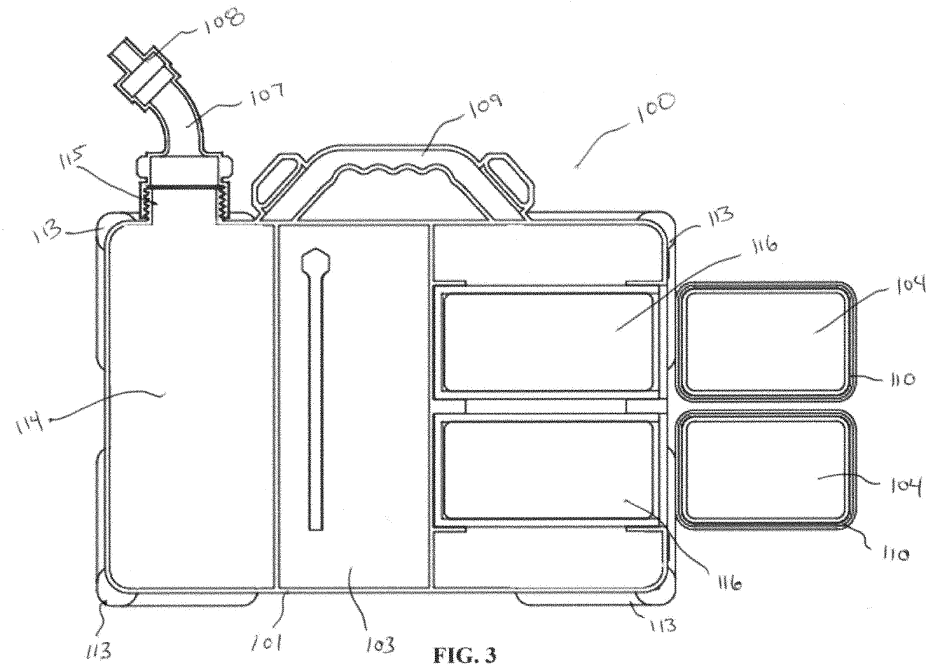

FIG. 3 shows a cross sectional view of combination service can 100 having vessel 114 within housing 101. Vessel 114 has an internal volume that is adapted to contain, transport and dispense chain and bar oil, or other fluids that may be needed in the operation and maintenance of a power tool, including battery powered power tools. Vessel 114 can have an internal volume of between about 1 liter and about 4 liters. In a preferred embodiment, vessel 114 has an internal volume of between about 2.5 liters and about 3 liters. As used herein, the term “about” means the value or quantity that is referenced, or that varies (plus or minus) by up to 5%, up to 10%, or up to 20% of the value or quantity that is referenced. The internal volume of vessel 114 is in fluid communication with spout 107 through vessel aperture 115. Spout 107 can connect to vessel aperture 115 through a threaded connection, for example. Vessel 114 can have a see-through window (not shown) to permit a user to visualize the amount of fluid that is contained in vessel 114.

FIG. 3 shows batteries 116 occupying battery receptacles 102. Batteries 116 can removably interface with battery receptacles 102 in a mating relationship such as in a rail or track relationship. In a preferred embodiment, battery receptacles 102 are adapted to removably interface with power tool batteries, such as chainsaw batteries. Batteries 116 can be held in place in battery receptacles 102 by the closure of battery receptacle doors 104. Batteries 116 can also be held in place in battery receptacles 102 under tension by a locking mechanism wherein batteries 116 click into place, for example. Battery receptacles 102 and batteries 116 can interface with one another according to various power tool charger/battery interface configurations which are known in the art, such as in use by Makita™, Stihl™, Black and Decker™, Milwaukee™, DeWalt™, and Husgvarna™. Battery receptacles 102 can be adapted to interface with single-celled batteries, or battery packs which comprise a series of battery cells. Batteries 116 can be lithium-ion batteries, for example.

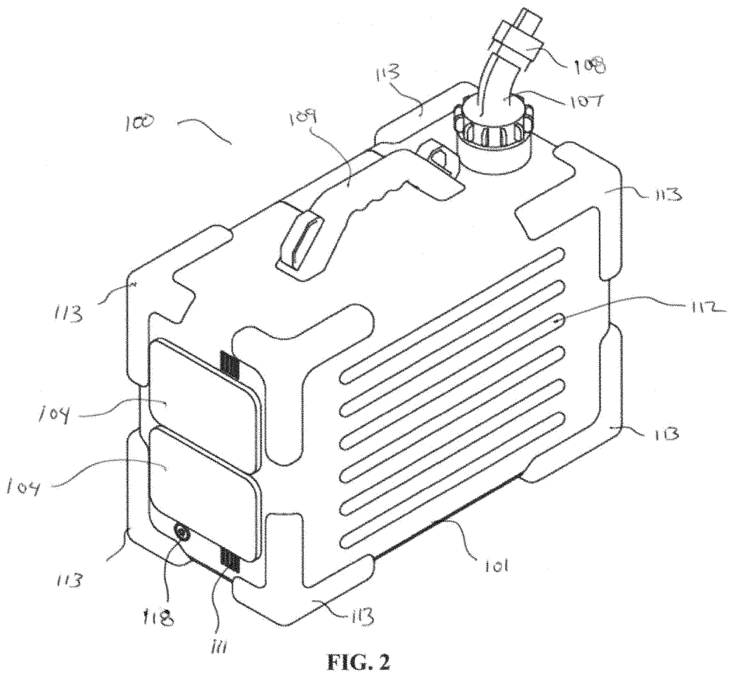

Battery receptacles 102 comprise first electrical connectors (not shown) for electrically coupling to the positive and negative terminals on batteries 116 when batteries 116 are placed in battery receptacles 102. The first electrical connectors are electronically coupled to second electrical connector 118 which is adapted to electrically couple to an external power source, such as a wall socket or other AC power source. In the embodiment shown in FIGS. 1 and 2, second electrical connector 118 is a female plug that is adapted to receive a male plug counterpart. In other embodiments, second electrical connector 118 is adapted to interface with a DC power source, such as a vehicle cigarette lighter. The first electrical connectors can assume any configuration suitable for conducting charging voltage to rechargeable batteries for power tools. Suitable connections for the first electrical connectors and second electrical connector 118, include, but are not necessarily limited to, pins, spring-loaded pins (e.g., pogo pins), plates, jacks, blades, sockets, plugs, wire harnesses, toggles, push-pull connectors, screw-in shells, bayonet systems, USB receptacles and plugs, and the like. In one non-limiting embodiment, combination service can 101 is adapted to interface with a charging dock. In such embodiments, the charging dock includes a charging dock electrical connector that mates with the second electrical connector on combination service can 100 so that charging voltage can be conducted to the first electrical connectors for charging batteries 116, the compartment charging ports, and charging battery 117. As with the first electrical connectors, the compartment charging ports in compartment 103 are electronically coupled to the second electronic connector so as to permit charging voltage to be conducted to the compartment charging ports so that the compartment charging ports can charge personal electronic devices as disclosed herein.

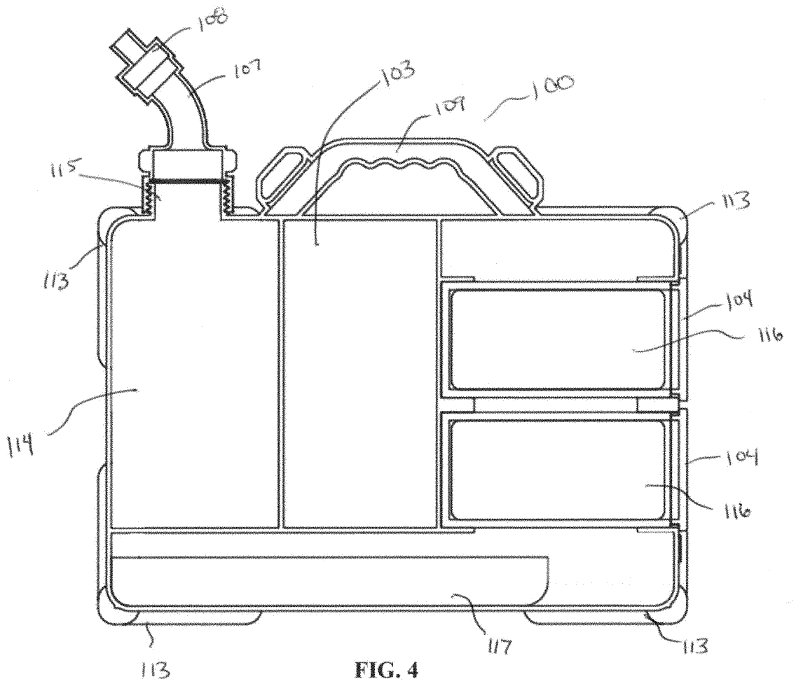

FIG. 4 depicts an embodiment of combination service can 100 that comprises charging battery 117 within housing 101. Charging battery 117 can span a portion of, or the entire bottom of, combination service can 100. Charging battery 117 can be permanently fixed to combination service can 100. Charging battery 117 is electronically coupled to the first electrical connectors and the compartment charging ports to conduct charging voltage to batteries 116 when batteries 116 are placed in battery receptacles 102, and to personal electronic devices that are plugged into the compartment charging ports. Charging battery 117 can provide a source of charging voltage when combination service can 100 is being used remotely away from any external power source which is typical in logging, forestry, and fire-fighting operations. Charging battery 117 can be a lithium-ion battery.

In embodiments that include charging battery 117, the first electrical connectors and charging battery 117 are electronically coupled to the second electrical connector to permit the second electrical connectors to conduct charging voltage to the first electrical connectors and charging battery 117. It will be understood that combination service can 100 can include an AC/DC adapter for converting AC voltage to DC voltage for charging batteries 116, charging battery 117, and charging personal devices in compartment 103 via the compartment charging ports therein. Combination service can 100 can further include chips, processors, or switches that are adapted to direct charging voltage from battery 117 to batteries 116 and the compartment charging ports when the second electrical connector is not connected to an external power source. First electrical connectors, the second electrical connector, the compartment charging ports, and charging battery 117 can be electronically coupled to one another by electricity conducting wires, such as copper wires, or copper alloy wires, for example. In some embodiments, combination service can 100 features LED lights or charged LED battery meter 111 for each battery receptacle 102 that indicate the charge status of batteries 116 as they are being charged or when they are completely charged.

In preferred embodiments, combination service can 100 provides bar and chain oil and a battery storage, transportation and charging function to battery powered chainsaws. However, combination service can 100 can be used to service other battery powered power tools, such as, for example, battery powered mowers, blowers, edgers, trimmers, hedge trimmers, jigsaws, circular saws, drills, routers, and the like.

In some embodiments, combination service can 100 provides a method of charging a rechargeable battery for a power tool. The method can be practiced by providing a rechargeable power tool battery in need of charging, providing combination service can 100, placing the rechargeable power tool battery in charging receptacle 102 to electrically couple the battery to a first electrical connector in battery receptacle 102, connecting the second electrical connector to an external power source so as to permit charging voltage to be conducted from the second electrical connector to the first electrical connector thereby charging the battery. In an alternate embodiment, the second electrical connector of combination service can 100 is not connected to an external power source and charging voltage from charging battery 117 is conducted to the first electrical connector thereby charging the battery.

1. A combination service can for power tools, comprising:
a) a vessel adapted to contain a liquid;
b) at least one battery receptacle that is adapted to receive a power tool battery; and
c) a first electrical connector that is adapted to electrically couple to said power tool battery when said power tool battery is placed in said at least one battery receptacle.

2. The combination service can of claim 1, further comprising a second electrical connector electronically coupled to said first electrical connector, wherein said second electrical connector is adapted to electrically couple to an external power source.

3. The combination service can of claim 1, further comprising a charging battery that is electronically coupled to said first electrical connector and said second electrical connector, wherein said charging battery is adapted to charge said power tool battery when said power tool battery is placed in said at least one battery receptacle.

4. The combination service can of claim 1, wherein said at least one battery receptacle is adapted to receive a chainsaw battery.

5. The combination service can of claim 1, wherein said at least one battery receptacle comprises a guide rail that is adapted to mate with said power tool battery.

6. The combination service can of claim 1, further comprising a locking mechanism that is adapted to releasably hold said power tool battery in said at least one battery receptacle.

7. The combination service can of claim 1, wherein said vessel is adapted to contain chainsaw oil.

8. The combination service can of claim 1, further comprising a compartment that is adapted to store one or more power tool accessories, one or more of said power tool battery, one or more personal electronic devices, or combinations thereof.

9. The combination service can of claim 8, wherein said compartment is positioned between said vessel and said at least one battery receptacle.

10. The combination service can of claim 8, wherein said compartment comprises one or more charging ports that are adapted to charge a personal electronic device.

11. The combination service can of claim 8, wherein said compartment is covered by a compartment door, wherein said compartment door optionally comprises a seal that is adapted to weatherproof said compartment.

12. The combination service can of claim 8, wherein said vessel, said at least one battery receptacle, and said compartment are enclosed in a housing.

13. The combination service can of claim 12, wherein said housing comprises a handle.

14. The combination service can of claim 12, wherein said housing comprises a spout that is adapted to dispense a liquid from said vessel.

15. The combination service can of claim 1, wherein said at least one battery receptacle is covered by a battery receptacle door, wherein said battery receptacle door optionally comprises a seal that is adapted to weatherproof said at least one battery receptacle.

16. The combination service can of claim 15, wherein said battery receptacle door is adapted to maintain contact between said first electrical connector and terminals on said power tool battery when said power tool battery is placed in said at least one battery receptacle.

17. The combination service can of claim 1, wherein said combination service can comprises two or more of said at least one battery receptacle.

18. The combination service can of claim 1, wherein said vessel has an internal volume that is between about 1 liter and about 3 liters.

19. The combination service can of claim 1, further comprising an AC/DC adapter.

20. The combination service can of claim 19, wherein said AC/DC adapter is electronically coupled to said first electrical connector.
